(19) United States
(12) Patent Application Publication
(10) Pub. No.: US 2021/0101375 A1
(43) Pub. Date: Apr. 8, 2021

(54) POLYFLUOROALKYL SUBSTANCES (PFAS) DIFFUSION PREVENTING SYSTEM

(71) Applicant: KURARAY CO., LTD., Kurashiki-shi (JP)

(72) Inventor: Edgard CHOW, Houston, TX (US)

(73) Assignee: KURARAY CO., LTD., Kurashiki-shi (JP)

(21) Appl. No.: 17/065,557

(22) Filed: Oct. 8, 2020

Related U.S. Application Data
(60) Provisional application No. 62/912,249, filed on Oct. 8, 2019.

(51) Int. Cl. B32B 27/08; B32B 27/30; B32B 7/12

(52) U.S. Cl. CPC B32B 27/08; B32B 27/306; B32B 7/12; B32B 2250/05; B32B 2250/24; B32B 2250/40; B32B 2439/40; B32B 2307/7242; B32B 2307/7265; B32B 2329/00; B32B 2307/73; B32B 2307/732; B32B 2250/42

(57) ABSTRACT

The present invention relates to a polyfluoroalkyl substance (PFAS) diffusion preventing system comprising a multilayer polyolefin based article (such as a geomembrane) with at least one layer of ethylene-vinyl alcohol resin (EVOH), wherein the system contains at least one of a cover, a liner and/or a container as such multilayer article.

### CROSS-REFERENCE TO RELATED APPLICATIONS

This application claims priority under 35 U.S.C. § 119 from U.S. Provisional Application Ser. No. 62/912,249 (filed 8 Oct. 2019), the disclosure of which is incorporated by reference herein for all purposes as if fully set forth.

### FIELD OF THE INVENTION

The present invention relates to a polyfluoroalkyl substances (PFAS) diffusion preventing system comprising a multilayer polyolefin based article (such as a geomembrane) with at least one layer of ethylene-vinyl alcohol resin (EVOH). The system contains at least one of a cover, a liner and/or a container as such multilayer article. It is particularly concerned with articles having good barrier for perfluoroalkyl substances, and it is economical and durable.

### BACKGROUND OF THE INVENTION

Besides typical landfill leachate contaminants such as benzene and trichloroethylene, a new wave of emerging contaminants referred to as perfluoroalkyl substances (PFAS) has been increasingly reported in the environmental news lately. These chemicals originate from the manufacturing of various water-resistant coatings used in outdoor furniture, apparel and shoes, non-stick coatings used in frying pans and fire-retardant foams. Additionally, these compounds are recalcitrant and persistent (strong and stable carbon-fluorine bond), highly mobile in the environment (both hydrophobic and oleophobic), do not readily adsorb into rock or soil and infiltrate readily into surface and ground water. Finally, these compounds have a long half-life and there is mounting evidence of health concerns at environmental concentrations. PFAS are bio-accumulative in wildlife and humans because they typically remain in the body for extended periods of time. Laboratory PFAS exposure studies on animals have shown problems with growth and development, reproduction, and liver damage. Close to two hundred contaminated sites are being tracked in United States alone that include firefighter training facilities, manufacturing sites, landfills and others.

Excavation with offsite incineration is a PFAS treatment practice that can be used but it can be costly especially if the incineration facility is distant. General treatments include the use of granular activated carbon, ion exchange resins, and adsorbents such as surface modified clays. Onsite excavation in combination with controlled bio piles that are lined and/or covered with geomembranes or other containment systems can be used but these systems are only effective if the materials used have high barrier or relatively low permeation coefficients against PFAS. Other PFAS treatment methods such as reverse osmosis are also used to remove these fluorinated compounds, and the leachate ponds could benefit from an effective barrier to contain the concentrates from diffusing through the liner. New treatment methods include oxidation/reduction (ozone, plasma, electrochemical oxidation, zero valent iron reduction, etc.)(See WO2018035474A1); however, application of these technologies is limited by their requirement of high energy input and/or special equipment.

On the other hand, geomembranes are commonly used for the fabrication of liners and covers for the geotechnical industry, such as in refuse landfill, sewage and waste residue treatment plants, containment of residuals from oil and gas fields, and the like. Geomembrane materials are commonly homogeneous (made of one type of material), e.g. low-, medium- and high-density polyethylene (LDPE, MDPE, HDPE), polypropylene (PP), PVC, butyl rubber, chlorosulphonated polyethylene (CSPE/CPM), ethylene interpolymer alloy (EIA), or nitrile butadiene (NBR). Especially, EVOH is known for its low permeation of gases and volatile organic compounds (VOC) relative to other commonly used thermoplastic polymers, and has been considered for geomembrane applications.

EP2489509A1 discloses a flexible multi-layer ground membrane that comprises the polyamide layers, EVOH layers and polyolefin layers that are bonded together. The chemical resistance of a polyolefin geomembrane, which is non-polar in nature (and so prevents the passage of polar liquids such as methanol) can be significantly increased by incorporating layers of polar polymers. The converse is also valid, i.e. the chemical resistance of a polar material, e.g. a polyamide, can be significantly increased by incorporating layers of non-polar polymers. An EVOH layer also provides a highly effective diffusion barrier to polar liquids in the membrane.

However, the prior art does not teach a system comprising an EVOH-containing multilayer film that exhibits excellent barrier resistance properties for PFAS.

The objective of this invention, therefore, is to establish an effective diffusion barrier to emerging contaminants known in the industry as PFAS. It has been found that an EVOH geomembrane system can be an effective way to remediate PFAS-contaminated soil for treatment while containing the contaminants and reducing transportation costs.

### SUMMARY OF THE INVENTION

In accordance with the present invention, an effective PFAS diffusion preventing system has been found comprising a multilayer article (such as a geomembrane) with at least one layer of an EVOH resin composition as a core (interior) layer. The system contains at least one of a cover, a liner or a container made from such geomembrane.

In one embodiment, the present invention addresses the above-described problem by providing a system containing a PFAS contaminated material, comprising at least:

(1) a PFAS contaminated material,

(2) a containment area or container containing the PFAS contaminated material, and

(3) at least one of a cover or a liner for the containment area or container,

wherein at least one of the cover, the liner or the container is a multilayer article comprising at least one core layer of an ethylene-vinyl alcohol resin composition.

In another embodiment, the ethylene-vinyl alcohol resin composition of the core layer comprises an ethylene-vinyl alcohol copolymer with a degree of saponification of about 99 mol % or greater, measured as described below.

In another embodiment, the ethylene-vinyl alcohol copolymer has an ethylene content of about 18 mol % or greater to about 55 mol % or less, measured as described below.

In another embodiment, the multilayer article comprises at least one external layer of a polyolefin resin composition.

In another embodiment, the multilayer article is a film or a sheet. In another embodiment, the multilayer article is a geomembrane.

In another embodiment, the system comprises a liner for the containment area or container, and further comprises a trench and/or a pipe to collect a runoff on the liner. Such runoff can be used to monitor PFAS content in the runoff and/or send the runoff to a treatment system. In one embodiment, such liner is a multilayer article comprising at least one core layer of an ethylene-vinyl alcohol resin composition.

Also provided is a method of containing a PFAS contaminated material in and with the above system.

Also, according to one aspect of the present invention, the multilayer article has permeation coefficient for PFAS of less than about 3.6×10⁻¹⁷ m²/s, measured as described below.

It is particularly concerned with a film having good barrier properties for PFAS, which is economical and has system durability. According to the present invention, therefore, a system is provided that has excellent PFAS barrier and is also suitable for long-term geomembrane use.

These and other embodiments, features and advantages of the present invention will be more readily understood by those of ordinary skill in the art from a reading of the following detailed description.

### DETAILED DESCRIPTION

The present invention relates to a PFAS diffusion preventing system comprising a multilayer article, such as a geomembrane, with at least one core layer of an ethylene-vinyl alcohol resin composition. The system contains at least one of a container, cover or a liner made from such multilayer article. Further details are provided below.

In the context of the present description, all publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this disclosure belongs. In case of conflict, the present specification, including definitions, will control.

Except where expressly noted, trademarks are shown in upper case.

Unless stated otherwise, all percentages, parts, ratios, etc., are by weight.

Unless stated otherwise, pressures expressed in psi units are gauge, and pressures expressed in kPa units are absolute. Pressure differences, however, are expressed as absolute (for example, pressure 1 is 25 psi higher than pressure 2).

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range.

When the term “about” is used, it is used to mean a certain effect or result can be obtained within a certain tolerance, and the skilled person knows how to obtain the tolerance. When the term “about” is used in describing a value or an end-point of a range, the disclosure should be understood to include the specific value or end-point referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus.

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Optional additives as defined herein, at a level that is appropriate for such additives, and minor impurities are not excluded from a composition by the term “consisting essentially of”.

Further, unless expressly stated to the contrary, “or” and “and/or” refers to an inclusive and not to an exclusive. For example, a condition A or B, or A and/or B, is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the disclosure. This description should be read to include one or at least one and the singular also includes the plural unless it is obvious that it is meant otherwise.

The term “predominant portion” or “predominantly”, as used herein, unless otherwise defined herein, means greater than 50% of the referenced material. If not specified, the percent is on a molar basis when reference is made to a molecule (such as hydrogen and ethylene), and otherwise is on a mass or weight basis (such as for additive content).

The term “substantial portion” or “substantially”, as used herein, unless otherwise defined, means all or almost all or the vast majority, as would be understood by the person of ordinary skill in the context used. It is intended to take into account some reasonable variance from 100% that would ordinarily occur in industrial-scale or commercial-scale situations.

The term “depleted” or “reduced” is synonymous with reduced from originally present. For example, removing a substantial portion of a material from a stream would produce a material-depleted stream that is substantially depleted of that material. Conversely, the term “enriched” or “increased” is synonymous with greater than originally present.

As used herein, the term “copolymer” refers to polymers comprising copolymerized units resulting from copolymerization of two or more comonomers. In this connection, a copolymer may be described herein with reference to its constituent comonomers or to the amounts of its constituent comonomers, for example “a copolymer comprising ethylene and 15 mol % of a comonomer”, or a similar description. Such a description may be considered informal in that it does not refer to the comonomers as copolymerized units; in that it does not include a conventional nomenclature for the copolymer, for example International Union of Pure and Applied Chemistry (IUPAC) nomenclature; in that it does not use product-by-process terminology; or for another reason. As used herein, however, a description of a copolymer with reference to its constituent comonomers or to the amounts of its constituent comonomers means that the copolymer contains copolymerized units (in the specified amounts when specified) of the specified comonomers. It follows as a corollary that a copolymer is not the product of a reaction mixture containing given comonomers in given amounts, unless expressly stated in limited circumstances to be such.

For convenience, many elements of the present invention are discussed separately, lists of options may be provided and numerical values may be in ranges; however, for the purposes of the present disclosure, that should not be considered as a limitation on the scope of the disclosure or support of the present disclosure for any claim of any combination of any such separate components, list items or ranges. Unless stated otherwise, each and every combination possible with the present disclosure should be considered as explicitly disclosed for all purposes.

Although methods and materials similar or equivalent to those described herein can be used in the practice or testing of the present disclosure, suitable methods and materials are described herein. The materials, methods, and examples herein are thus illustrative only and, except as specifically stated, are not intended to be limiting.

### EVOH Resin Composition

A core layer of a multilayer article in accordance with the present invention is formed from an EVOH resin composition.

The EVOH of the EVOH resin composition is a copolymer having as a main structural unit an ethylene unit and a vinyl alcohol unit.

The EVOH desirably has, as a lower limit of ethylene unit content (a proportion of the number of ethylene units to the total number of monomer units in the EVOH), an ethylene unit content of about 20 mol % or greater, or about 22 mol % or greater, or about 24 mol % or greater. On the other hand, the EVOH desirably has, as an upper limit of ethylene unit content, an ethylene unit content of about 60 mol % or less, or about 55 mol % or less, or about 50 mol % or less. The EVOH having an ethylene unit content of no less than the lower limit gives a crosslinked product an excellent oxygen barrier properties in high humidity and gives excellent melt moldability. In addition, the EVOH having an ethylene unit content of no greater than the upper limit gives excellent oxygen barrier properties.

The EVOH typically has, as a lower limit of degree of saponification (a proportion of the number of vinyl alcohol units to the total number of the vinyl alcohol units and vinyl ester units in the EVOH), a degree of saponification of about 80 mol % or greater, or about 95 mol % or greater, or about 99 mol % or greater. On the other hand, the EVOH typically has, as an upper limit of degree of saponification, a degree of saponification of (substantially) 100 mol %, or about 99.99 mol % or less. The EVOH having a degree of saponification of no less than the lower limit gives excellent oxygen barrier properties and thermal stability.

A method of preparing the ethylene-vinyl alcohol copolymer is not particularly limited, and may include well-known preparing methods. For example, in a general method, an ethylene-vinyl ester copolymer obtained by copolymerizing ethylene and vinyl ester monomer is saponified under the presence of a saponification catalyst, in an organic solvent including alcohol.

Examples of the vinyl ester monomer may include vinyl formate, vinyl acetate, vinyl propionate, vinyl butyrate, vinyl isobutyrate, vinyl pivalate, vinyl versatate, vinyl caproate, vinyl caprylate, vinyl laurate, vinyl palmitate, vinyl stearate, vinyl oleate, and vinyl benzoate. Particularly, vinyl acetate is preferable.

A method of copolymerizing ethylene and vinyl ester monomer may include well-known methods such as solution polymerization, bulk polymerization, suspension polymerization, and emulsion polymerization. As a polymerization initiator, an azo-based initiator, peroxide-based initiator, redox-based initiator, and the like may be properly selected according to a polymerization method. The copolymerization may be performed under presence of thiol compounds such as thioacetic acid and mercaptopropionic acid, or other chain-transfer agents.

For the saponification reaction, alcoholysis, hydrolysis, and the like, which uses a well-known alkali catalyst or acidic catalyst as a saponification catalyst in an organic solvent, may be used. In particular, a saponification reaction using a caustic soda catalyst with methanol as a solvent is simple and easy, and thus, most preferable.

The EVOH used in the EVOH resin composition may be a combination of two or more different types of EVOH. For example, the EVOH can be composed of a mixture of two or more types of EVOH that are different in ethylene unit content, with the combination having an ethylene content that is calculated as an average value from a mixed mass ratio. In this case, the difference between two types of EVOH that have different ethylene unit contents is typically about 30 mol % or less, or about 20 mol % or less, or about 15 mol % or less.

Similarly, the EVOH can be composed of a mixture of two or more types of EVOH that are different in degree of saponification, with the combination having a degree of saponification that is calculated as an average value from a mixed mass ratio. In this case, the difference in degree of saponification is typically about 7% or less, or about 5% or less.

When the EVOH resin composition is molded into a multilayered structure that is desired, as a multilayered structure, to achieve a balance between thermal moldability and oxygen barrier properties at a high level, the EVOH is preferably used that is obtained by mixing an EVOH having an ethylene unit content of from about 24 mol % to about 34 mol % and a degree of saponification of about 99% or greater, with an EVOH having an ethylene unit content of from about 34 mol % to about 50 mol % and a degree of saponification of about 99% or greater, in a blending mass ratio of about 60/40 to about 90/10.

The ethylene unit content and the degree of saponification of the EVOH can be determined by nuclear magnetic resonance (NMR) analysis by conventional methods as recognized by one or of ordinary skill in the relevant art.

The EVOH typically has, as a lower limit of a melt flow rate (a measured value at a temperature of 190° C. and a load of 2160 g in accordance with JIS K 7210), a melt flow rate of about 0.1 g/10 min or more, or about 0.5 g/10 min or more, or about 1 g/10 min or more, or about 3 g/10 min or more. On the other hand, the EVOH typically has, as an upper limit of a melt flow rate, a melt flow rate of about 200 g/10 min or less, or about 50 g/10 min or less, or about 30 g/10 min or less, or about 15 g/10 min or less, or about 10 g/10 min or less. The EVOH having a melt flow rate value in the above range improves melt kneadability and melt moldability of a resultant resin composition.

A modified EVOH can also be used. For example, a modified EVOH can have at least one structural unit selected from, for example, structural units (I) and (II) shown below.

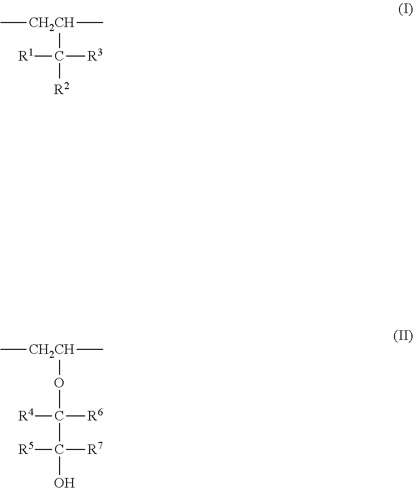

When present, such the structural unit are present at a ratio of from about 0.5 mol % to about 30 mol % based on the total structural units. Such a modified EVOH may improve flexibility and moldability of a resin or a resin composition and the interlayer adhesion.

Each of R¹, R² and R³ in the above formula (I) independently represents a hydrogen atom, an aliphatic hydrocarbon group having 1 to 10 carbon atoms, an alicyclic hydrocarbon group having 3 to 10 carbon atoms, an aromatic hydrocarbon group having 6 to 10 carbon atoms, or a hydroxy group. Also, one pair of R¹, R² or R³ may be combined together (excluding a pair of R¹, R² or R³ in which both of them are hydrogen atoms). Further, the aliphatic hydrocarbon group having 1 to 10 carbon atoms, the alicyclic hydrocarbon group having 3 to 10 carbon atoms, or the aromatic hydrocarbon group having 6 to 10 carbon atoms may have the hydroxy group, a carboxy group or a halogen atom. On the other hand, each of R⁴, R⁵, R⁶ and R⁷ in the above formula (II) independently represents the hydrogen atom, the aliphatic hydrocarbon group having 1 to 10 carbon atoms, the alicyclic hydrocarbon group having 3 to 10 carbon atoms, the aromatic hydrocarbon group having 6 to 10 carbon atoms, or the hydroxy group. R⁴ and R⁵, or R⁶ and R⁷ may be combined together (excluding when both R⁴ and R⁵ or both R⁶ and R⁷ are hydrogen atoms). Also, the aliphatic hydrocarbon group having 1 to 10 carbon atoms, the alicyclic hydrocarbon group having 3 to 10 carbon atoms, or the aromatic hydrocarbon group having 6 to 10 carbon atoms may have the hydroxy group, an alkoxy group, the carboxy group or the halogen atom.

In another example, the following modified EVOH can be used as the EVOH, wherein the modified EVOH copolymer is represented by a following formula (III), contents (mol %) of a, b, and c based on the total monomer units that satisfy following formulae (1) through (3), and a degree of saponification (DS) defined by a following formula (4) is not less than about 90 mol %.

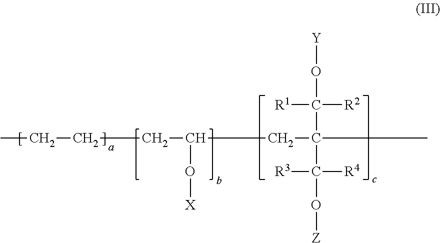

18≤a≤55 (1)

0.01≤c≤20 (2)

[100−(a+c)]×0.9≤b≤[100−(a+c)] (3)

DS=[(Total Number of Moles of Hydrogen Atoms in X, Y, and Z)/(Total Number of Moles of X, Y, and Z)]×100 (4)

In the formula (III), each of R¹, R², R³ and R⁴ independently denotes a hydrogen atom or an alkyl group having a carbon number of from 1 to 10, and the alkyl group may include a hydroxyl group, an alkoxy group, or a halogen atom. Each of X, Y, and Z independently denotes a hydrogen atom, a formyl group, or an alkanoyl group having a carbon number of from 2 to 10.

The EVOH may also contain, as a copolymer unit, a small amount of another monomer unit other than the ethylene unit and the vinyl alcohol unit within a range not to inhibit the purpose of the present invention. Examples of such a monomer include α-olefins such as propylene, 1-butene, isobutene, 4-methyl-1-pentene, 1-hexene, and 1-octene; unsaturated carboxylic acids such as itaconic acid, methacrylic acid, acrylic acid, and maleic acid, salts thereof, partial or complete esters thereof, nitriles thereof, amides thereof, and anhydrides thereof; vinylsilane compounds such as vinyltrimethoxysilane, vinyltriethoxysilane, vinyltri(2-methoxyethoxy)silane, and γ-methacryloxypropyltrimethoxysilane; unsaturated sulfonic acids or salts thereof; unsaturated thiols; and vinylpyrrolidones.

The EVOH resin composition may contain other optional components within a range not to impair the effects of the present invention. Examples of such other components include, for example, a boron compound, an alkali metal salt, a phosphoric acid compound, an oxidizable substance, another polymer, an oxidization accelerator, and another additive.

Addition of a boron compound to the EVOH resin composition may be advantageous in terms of improving melt viscosity of the EVOH and obtaining a homogenous coextrusion molded product or a coinjection molded product. Examples of suitable boron compounds include boric acids, a boric acid ester, a boric acid salt, and boron hydrides. Specific examples of the boric acids include orthoboric acid (hereinafter, also merely referred to as “boric acid”), metaboric acid and tetraboric acid. Specific examples of the boric acid ester include triethyl borate and trimethyl borate. Specific examples of the boric acid salt include alkali metal salts and alkaline earth metal salts of the above various types of boric acids, and borax. Among these compounds, orthoboric acid is preferred.

When a boron compound is added, the content of the boron compound in the composition is typically from about 20 ppm, or from about 50 ppm, to about 2000 ppm, or to about 1500 ppm, in terms of the boron element equivalent. The content of the boron compound in this range can give EVOH that is produced while torque variation is suppressed during heat melting.

The EVOH resin composition may also contain an alkali metal salt in an amount of from about 5 ppm, or from about 20 ppm, or from about 30 ppm, to about 5000 ppm, or to about 1000 ppm, or to about 500 ppm, in terms of the alkali metal element equivalent. The resin composition containing an alkali metal salt in the above range can improve the interlayer adhesiveness and the compatibility. An alkali metal is exemplified by, for example, lithium, sodium, and potassium, and the alkali metal salt is exemplified by, for example, an aliphatic carboxylic acid salt, an aromatic carboxylic acid salt, a phosphoric acid salt, and a metal complex of the alkali metal. Examples of the alkali metal salt include sodium acetate, potassium acetate, sodium phosphate, lithium phosphate, sodium stearate, potassium stearate, and sodium salts of ethylene diamine tetraacetic acid. Especially, sodium acetate, potassium acetate, and sodium phosphate are preferred.

The EVOH resin composition may also contain a phosphoric acid compound in an amount of from about 1 ppm, or from about 5 ppm, or from about 10 ppm, to about 500 ppm, or to about 300 ppm, or to about 200 ppm, in terms of the phosphate radical equivalent. Blending the phosphoric acid compound in the above range can improve the thermal stability of the EVOH and suppress, in particular, generation of gel-state granules and coloring during melt molding for a long period of time.

The type of the phosphoric acid compound added to the EVOH resin composition is not particularly limited, and there can be used, for example, various types of acids such as phosphoric acid and phosphorous acid, and salts thereof. The phosphoric acid salt may be any form of a primary phosphoric acid salt, a secondary phosphoric acid salt, and a tertiary phosphoric acid salt. Although the cation species of the phosphoric acid salt is not also particularly limited, an alkali metal or an alkaline earth metal is preferred as the cation species. Especially, the phosphorus compound is preferably added in the form of sodium dihydrogen phosphate, potassium dihydrogen phosphate, disodium hydrogen phosphate or dipotassium hydrogen phosphate.

The EVOH resin composition may also contain various types of other additives within a range not to impair the effects of the present invention. Examples of such other additives include an antioxidant, a plasticizer, a heat stabilizer (melt stabilizer), a photoinitiator, a deodorizer, an ultraviolet ray absorber, an antistatic agent, a lubricant, a colorant, a filler, a drying agent, a bulking agent, a pigment, a dye, a processing aid, a fire retardant, and an anti-fogging agent.

### Adhesive Resin Contained in Adhesive Layer

As indicated above, the multilayer article in accordance with the present invention may contain at least one adhesive layer based. Suitable adhesive layers are generally known to those of ordinary skill in the art based on the two layers being adhered.

In one embodiment, the adhesive layer(s) is an acid-functionalized polymer resin composition. For adhesion between the layer of the EVOH resin composition (EVOH resin composition layer) and the layer of the hydrophobic thermoplastic resin composition, an adhesive resin layer is typically interposed between these layers. Typical examples of the adhesive resin include carboxyl group-containing modified polyolefin resins obtained by chemically binding an unsaturated carboxylic acid or an anhydride thereof to a polyolefin resin. Specific examples of the adhesive resin include polyethylenes modified with maleic anhydride, polypropylenes modified with maleic anhydride, a maleic anhydride-modified ethylene-ethyl acrylate copolymer, and a maleic anhydride-graft-modified ethylene-vinyl acetate copolymer. In terms of mechanical strength and molding processability, polyethylenes modified with maleic anhydride and polypropylenes modified with maleic anhydride are preferable, and polyethylenes modified with maleic anhydride are particularly preferable among these.

Regarding the melt viscosity of the adhesive resin, the MFR at 190° C. and a 2160-g load typically has a lower limit of about 0.1 g/10 minutes, or about 0.2 g/10 minutes, and typically has an upper limit of about 100 g/10 minutes, or about 60 g/10 minutes. The difference between the MFR of the adhesive resin and the MFR of the EVOH resin composition is preferably small. When the melt viscosity of the adhesive resin is as described above, an excellent multilayer article having excellent adhesive strength without any layer turbulence can be obtained.

### Hydrophobic Thermoplastic Resin Composition Contained in Other Layers

Other constituent layers of the multilayer article of the present invention, which are not the layers of the EVOH resin composition and the adhesive resin composition, are not particularly limited.

In order to avoid moisture, which can reduce the barrier property of the EVOH resin composition, the resin contained in other constituent layer is typically a hydrophobic thermoplastic resin composition comprising, as a predominant portion, one or more hydrophobic thermoplastic resins. Examples of suitable hydrophobic thermoplastic resins include polyolefin resins; polyethylenes such as linear low-density polyethylenes, low-density polyethylenes, ultra-low-density polyethylenes, ultra-low-density linear polyethylenes, medium-density polyethylenes, and high-density polyethylenes; polyethylene copolymer resins such as ethylene-α-olefin copolymers; polypropylene resins such as polypropylenes, ethylene-propylene (block and random) copolymers, and propylene-α-olefin (C4-20 α-olefin) copolymers; polybutenes; polypentenes; graft polyolefins obtained by graft modification of these polyolefins with an unsaturated carboxylic acid or an ester thereof; cyclic polyolefin resins; ionomers; an ethylene-vinyl acetate copolymer; an ethylene-acrylic acid copolymer; an ethylene-acrylic acid ester copolymer; a polyester resin; a polyamide resin; polyvinyl chloride; polyvinylidene chloride; acrylic resins; polystyrenes; vinyl ester resins; polyester elastomers; polyurethane elastomers; halogenated polyolefins such as chlorinated polyethylenes and chlorinated polypropylenes; and aromatic and aliphatic polyketones. In terms of mechanical strength and molding processability, polyolefin resins are preferable, and polyethylenes and polypropylenes are particularly preferable among these.

For the hydrophobic thermoplastic resin composition, an anti-ultraviolet agent is preferably added. Examples of the anti-ultraviolet agent include an ultraviolet absorber, a light stabilizer, and a colorant.

The content of the anti-ultraviolet agent in the hydrophobic thermoplastic resin is typically from about 1% by weight, or about 2% by weight, or about 3% by weight, to about 10% by weight, or to about 8% by weight, or to about 5% by weight, based on the total weight of the hydrophobic thermoplastic resin composition. When the content is less than these ranges, the hydrophobic thermoplastic resin composition tends to be degraded by ultraviolet light. When the content is greater than these ranges, the hydrophobic thermoplastic resin composition has poor mechanical strength.

Regarding the melt viscosity of the hydrophobic thermoplastic resin composition, the MFR at 190° C. and a 2160 g load typically has a lower limit of about 0.1 g/10 minutes, or about 0.2 g/10 minutes, and typically has an upper limit of about 100 g/10 minutes, or about 60 g/10 minutes. The difference between the MFR of the hydrophobic thermoplastic resin composition and the MFR of the EVOH resin composition is preferably small. When the melt viscosity of the hydrophobic thermoplastic resin composition is as described above, an excellent multilayer article without layer turbulence can be obtained.

Alternatively, other functional layers can be incorporated into the multilayer films, such as the materials provide heat sealability and scuff resistance and toughness.

### Additional Optional Layers

As indicated above, the multilayer films in accordance with the present invention may contain more than 5 layers.

Typically, the optional additional layers will be one or more of the core layer, first interior layer or second outer layer, typically in combination with one or more adhesive layers.

### Multilayer Articles

In general aspects, the multilayer article of the present invention has a core layer of the EVOH resin composition. The multilayer articles may contain one or more other types of layers, for example, hydrophobic thermoplastic resin composition layers and adhesive layers.

Examples of the layer structure of the multilayer article is shown below, in which the EVOH resin composition layer (core layer) as EVOH, the (each) adhesive resin layer as AD (may be the same or different), and each hydrophobic thermoplastic resin composition layer as PO.

Five layers: PO/AD/EVOH/AD/PO

Six layers: PO/PO/AD/EVOH/AD/PO

Seven layers: PO/PO/AD/EVOH/AD/PO/PO, PO/AD/EVOH/AD/EVOH/AD/PO

Eight layers: PO/PO/AD/EVOH/AD/EVOH/AD/PO

Nine layers: PO/PO/AD/EVOH/AD/EVOH/AD/PO/PO

Eleven layers: PO/PO/AD/EVOH/AD/EVOH/AD/EVOH/AD/PO/PO

For preventing moisture in order to avoid deterioration of the barrier property, a structure, in which the EVOH resin composition layer is the core layer and the hydrophobic thermoplastic resin composition layer is used as the outer layer, is used, with the structure PO/AD/EVOH/AD/PO being preferred.

Regarding the thickness of a multilayer film in accordance with one embodiment of the present invention, in the case of a cover or a liner or a container, the total thickness thereof is typically from about 100 μm, or from about 300 μm, or from about 500 μm, or from about 800 μm, to about 4000 μm, or to about 3000 μm, or to about 2500 μm, or to about 2000 μm.

The thickness of each PO layer in the film is not particularly limited, but is typically from about 50 μm, or from about 100 μm, or from about 150 μm, to about 2000 μm, or to about from 1500 μm, or to about 1000 μm.

The thickness of each AD layer in the film is not particularly limited, but is typically from about 2 μm, or from about 5 μm, or from about 10 μm, to about 600 μm, or to about 400 μm, or to about 200 μm.

The thickness of each EVOH layer in the film is not particularly limited, but is typically from about 2 μm, or from about 5 μm, or from about 10 μm, to about 600 μm, or to about 400 μm, or to about 200 μm.

Methods of producing multilayer articles in accordance with the present invention are broadly classified into a process involving melting the EVOH resin composition, adhesive resin and hydrophobic thermoplastic resin, then molding the resultant melt (a melt molding process), for example. The melt molding procedure for obtaining the molded product is not limited, often exemplified by cast extrusion, blown extrusion, and the like. Specific examples thereof include the following: melt extrusion of EVOH resin composition, adhesive resin and hydrophobic thermoplastic resin to form each layer; coextruding all layers, the layers are then disposed in a side-by-side relationship to form a multilayer structure.

Methods of bonding the cover membrane and the liner membrane are wedge welding and extrusion welding methods, for example. For the wedge welding trials both split and solid wedge techniques can be used. These methods in the present invention are generally known, or as otherwise currently used in geomembrane applications as will be recognized by one of ordinary skill in the relevant art.

In one embodiment, the system comprises a liner for the containment area or container, and further comprises a trench and/or a pipe to collect a runoff on the liner. Such runoff can be used to monitor PFAS content in the runoff and/or send the runoff to a treatment system. In one embodiment, such liner is a multilayer article comprising at least one core layer of an ethylene-vinyl alcohol resin composition.

### PFAS Contaminated Material

PFAS are a class of man-made compounds that have been used to manufacture consumer products and industrial chemicals, including, inter alia, aqueous film forming foams (AFFFs). AFFFs have been the product of choice for firefighting at military and municipal fire training sites around the world.

PFAS may be used as surface treatment/coatings in consumer products such as carpets, upholstery, stain resistant apparel, cookware, paper, packaging, and the like, and may also be found in chemicals used for chemical plating, electrolytes, lubricants, and the like, which may eventually end up in the water supply.

PFAS are highly soluble in water, result in large, dilute plumes, and have a low volatility. PFAS are very difficult to treat largely because they are extremely stable compounds which include carbon-fluorine bonds. Carbon-fluorine bonds are the strongest known bonds in nature and are highly resistant to breakdown.

The per- and polyfluoroalkyl substances contained in PFAS contaminated materials, are not particularly limited. Examples of PFAS may include Perfluorobutyric acid (PFBA), Perfluoropentanoic acid (PFPeA), Perfluorobutane sulfonate (PFBS), Perfluorohexanoic acid (PFHxA), Perfluoroheptanoic acid (PFHpA), Perfluorohexane sulfonate (PFHxS), 6:2 Fluorotelomer sulfonate (6:2 FTS), Perfluorooctanoic acid (PFOA), Perfluoroheptane sulfonate (PFHpS), Perfluorooctane sulfonate (PFOS), Perfluorononanoic acid (PFNA), 8:2 Fluorotelomer sulfonate (8:2 FTS).

The content of the polyfluoroalkyl substances in the PFAS contaminated materials is typically from about 0.0000001% by weight, or about 0.000001% by weight, or about 0.0001% by weight, to about 0.01% by weight, or to about 0.008% by weight, or to about 0.005% by weight, or to about 0.001% by weight based on the total weight of the PFAS contaminated materials.

### EXAMPLES

The present invention is more specifically described by way of examples. The scope of the present invention, however, is not limited to these examples.

### Example 1

### LLDPE/AD/EVOH/AD/LLDPE Multilayer Film

### Conditions for Preparing Blown Film

The blown multilayer film was prepared under the following conditions, followed by trimming into a film.

### Layer Structure

3-material-5-layer (PO/AD/EVOH/AD/PO)

PO layer: LLDPE (SURPASS® FPs016-C, NOVA Chemicals Corporation, Calgary, Alberta Canada)

AD layer: MAh modified PE (ADMER™ NF498E, Mitsui Chemicals America. Inc., NY USA)

EVOH layer: EVOH (EVAL™ H171B, Kuraray America, Inc., Houston, Tex. USA) (Ethylene Content: 38 mol %, Saponification degree 99.9%, MFR=1.7 g/10 min)

### Conditions for Film Formation

Apparatus: a 7-material-7-layer blown film extruder (Brampton Engineering, Brampton, Ontario Canada)

### Extruder

Extruder A: 45-mmφ single screw extruder (L/D=24)

Extruder B: 30-mmφ single screw extruder (L/D=24)

Extruder C: 30-mmφ single screw extruder (L/D=24)

Extruder D: 30-mmφ single screw extruder (L/D=20)

Extruder E: 30-mmφ single screw extruder (L/D=24)

Extruder F: 30-mmφ single screw extruder (L/D=24)

Extruder G: 45-mmφ single screw extruder (L/D=24)

Film structure: A/B/C/D/E/F/G

Extruder A, B, F G are used for PO layers, Extruder C and E are used for AD layers, Extruder D is used for EVOH layer.

Die: 150 mm D

### Temperature Setting (° C.):

Extruder A: C1/C2/C3/A=193/227/216/221

Extruder B: C1/C2/C3/A=193/227/216/221

Extruder C: C1/C2/C3/A=193/227/216/221

Extruder D: C1/C2/C3/A=204/210/227/221

Extruder E: C1/C2/C3/A=193/227/216/221

Extruder F: C1/C2/C3/A=193/227/216/221

Extruder G: C1/C2/C3/A=193/227/216/221

Die: 221

Screw Rotation Speed (rpm)

Extruder A: 51.4

Extruder B: 66.7

Extruder C: 27.0

Extruder D: 38.3

Extruder E: 26.7

Extruder F: 67.0

Extruder G: 51.0

Blow up ratio: 1.91

### Evaluation of the Film

### Measuring of Thickness of EVOH Multilayer Film

Samples was collected from the multilayer film. Collected sample was cut by knife and sliced using a microtome (RM2165 manufactured by Leica). Layer thickness was measured using an optical microscope (Model: Eclipse ME600 optical microscope manufactured by Nikon). Film thickness is shown in below and in Table 1.

Total thickness: 118 micron

PO/AD/EVOH/AD/PO=48/6/11/6/47 micron

### PFAS Permeation Coefficients

Stainless steel diffusion cells with source and receptor compartments were used for aqueous diffusion test. The multilayer film sample was secured between the source and receptor compartments. The source and receptor were sampled until equilibrium was reached. Samples were taken frequently at early stages of testing, and a decreased frequency at later stages, when changes in concentration were smaller. Cells were agitated by magnetic stirrers and maintained at 22° C. Once equilibrium was reached, a mass balance was performed to check that there was no significant leakage from the cells during the tests. Samples are tested using a dilute aqueous PFOA/PFOS source solution with initial concentrations of approximately 20-30 ppb. Deionized water was placed into the cell receptor compartment.

Source and receptor diffusion samples were analyzed by Purge and Trap Gas Chromatography/Mass Spectrometry (P&T)-GC/MS using selective ion monitoring (SIM). (Hewlett Packard 5890 GC with a P&T unit and 5972 mass selective detector). The VOC P&T method is based on USDA method 8260B.

The diffusion from the source to the receptor was plotted normalized with respect to the initial source concentration (C) for the specific compound and the samples with time. The diffusion tests were characterized by a decrease in source concentration coupled with an increase in receptor concentration until both values eventually reach equilibrium. The vapor barriers reached equilibrium within approximately 240 days. The diffusion coefficients (D) and partition coefficients (S) were inferred by fitting the results of the theoretical model to the observed change in concentrations with time. And, permeation coefficients (P) were calculated by formula (IV) below and summarized in Table 1.

P=S*D (IV)

### Comparative Example 1

### LLDPE Monolayer Film

LLDPE monolayer film evaluated instead of blown multilayer film.

The film was produced by blown film line as the same manner as Example 1, except that LLDPE (SURPASS® FPs016-C, NOVA Chemicals Corporation, Calgary, Alberta Canada) was used for all of extruders.

Thickness was measured in the same manner as Example 1, and the results are shown in below and Table 1.

Total thickness: 97 micron

TABLE 1

| | | Thickness | | Receptor Concentration | | Estimate Permeation coefficients | |
|---|---|---|---|---|---|---|---|
| | | (μm) | | (ppb) | | (m²/s) | |
| | Film structure | Total | EVOH | PFOA | PFOS | PFOA | PFOS |
| Example 1 | LLDPE/AD/EVOH/AD/LLDPE | 118 | 11 | BQ⁽*¹⁾ | BQ | <3.6 × 10⁻¹⁷ | <3.5 × 10⁻¹⁷ |
| Comparative | LLDPE monolayer | 97 | — | ND⁽*²⁾ | 4.6 | <3.6 × 10⁻¹⁷ | 1.0 × 10⁻¹⁶ |
| Example 1 | | | | | | | |

⁽*¹⁾Below Quantification
⁽*²⁾Not Detected

The test results show that a blown EVOH multilayer film in accordance with the present invention is suitable for geomembrane applications in terms of a desirable combination of barrier properties for PFAS.

As shown in Table 1, the receptor sample of the LLDPE monolayer contained 4.6 ppb (0.0046 ppm) PFOS while PFOA concentration was below the detection. The detection level for these samples is 0.1 ppb, which is the lowest calibration standard used. The receptor sample from the blown EVOH multilayer film have PFOS and PFOA levels below the quantification, meaning that the contaminants are detected in the chromatograph at levels that are too low to quantify.

And the estimate permeation coefficient values for the LLDPE monolayer are less than 3.6×10⁻¹⁷ m2/s for PFOS and 1.0×10⁻¹⁶ m2/s for PFOA. The estimate permeation coefficient values for the blown EVOH multilayer film are less than 3.6×10⁻¹⁷ m2/s for PFOS and less than 3.5×10⁻¹⁷ m2/s for PFOA.

Confirmation of PFOS breakthrough for the LLDPE monolayer while there is still below the detection of PFOS for the blown EVOH multilayer film is a clear evidence that the EVOH layer is having good barrier for perfluoroalkyl substances.

1. A system containing a PFAS contaminated material, comprising at least:
(1) a PFAS contaminated material,
(2) a containment area or container containing the PFAS contaminated material, and
(3) a cover and/or a liner for the containment area or container,
wherein the cover and/or the liner and/or the container is a multilayer article comprising at least one core layer of an ethylene-vinyl alcohol resin composition.

2. The system of claim 1, wherein the ethylene-vinyl alcohol resin composition comprises a predominant amount of an ethylene-vinyl alcohol copolymer having a degree of saponification of about 99 mol % or greater.

3. The system of claim 1, wherein the ethylene-vinyl alcohol resin composition comprises a predominant amount of an ethylene-vinyl alcohol copolymer having an ethylene content of about 18 mol % or greater and about 55 mol % or less.

4. The system of claim 1, having permeation coefficient for PFAS of less than 3.6×10⁻¹⁷ m²/s.

5. The system of claim 1, wherein the total thickness of the multilayer article is from about 100 μm to about 4000 μm.

6. The system of claim 1, wherein a thickness of each core layer is from about 2 μm to about 600 μm.

7. The system of claim 1, wherein the multilayer articles further comprises one or more hydrophobic thermoplastic resin composition layers, and one or more adhesive layers.

8. The system of claim 7, wherein a thickness of each hydrophobic thermoplastic resin composition layer is from about 50 μm to about 2000 μm.

9. The system of claim 7, wherein a thickness of each adhesive layer is from about 2 μm to about 600 μm.

10. The system of claim 7, wherein the multilayer article has one of the following constructions:
Five layers: PO/AD/EVOH/AD/PO
Six layers: PO/PO/AD/EVOH/AD/PO
Seven layers: PO/PO/AD/EVOH/AD/PO/PO, PO/AD/EVOH/AD/EVOH/AD/PO
Eight layers: PO/PO/AD/EVOH/AD/EVOH/AD/PO
Nine layers: PO/PO/AD/EVOH/AD/EVOH/AD/PO/PO
Eleven layers: PO/PO/AD/EVOH/AD/EVOH/AD/EVOH/AD/PO/PO
wherein each EVOH is individually an EVOH resin composition layer, each AD is individually an adhesive resin layer, each PO is individually a layer of a hydrophobic thermoplastic resin composition.

11. The system of claim 1, wherein the multilayer article is a film.

12. The system of claim 1, wherein the system comprises a liner for the containment area or container, and further comprises a trench and/or a pipe to collect a runoff from the liner.

13. The system of claim 12, wherein the liner is a multilayer article comprising at least one core layer of an ethylene-vinyl alcohol resin composition.

14. A method of containing a PFAS contaminated material by using the system of claim 1.

15. A method of containing a PFAS contaminated material by using the system of claim 12.
